(19) United States
(12) Patent Application Publication
(10) Pub. No.: US 2005/0213561 A1
(43) Pub. Date: Sep. 29, 2005

(54) System, apparatus and method for address forwarding for a computer network

(75) Inventors: Hawkins Yao, San Jose, CA (US); Cheh-Suei Yang, Los Altos, CA (US); Richard Gunlock, Houston, TX (US); Michael Witkowski, Tomball, TX (US); Sompong Paul Olarig, Pleasanton, CA (US)

Correspondence Address: BAKER BOTTS, LLP, 910 LOUISIANA, HOUSTON, TX, 77002-4995, US

(73) Assignee: MaXXan Systems, Inc.

(21) Appl. No.: 11/138,723

(22) Filed: May 26, 2005

Related U.S. Application Data
(62) Division of application No. 10/015,047, filed on Oct. 26, 2001.

(51) Int. Cl. H04L 12/28

(52) U.S. Cl. 370/351; 370/469

(57) ABSTRACT

A system, apparatus and method for an efficiently performing address lookups and switching for computer networks is disclosed. The present disclosure provides for address translation between network devices utilizing different protocols. The system, apparatus and method described herein provide for address translation for encapsulated communications to enable mixed protocol communications using a network switch fabric system.

### CROSS REFERENCE TO RELATED APPLICATIONS

The present application is a divisional of, and claims priority to, U.S. patent application Ser. No. 10/015,047, filed Oct. 26, 2001, entitled “SYSTEM, APPARATUS AND METHOD FOR ADDRESS FORWARDING FOR A COMPUTER NETWORK,” by Yao, et al.(the same inventors as the present application); this application is also related to divisional U.S. patent application Ser. No. [069099.0125], which was filed on May 24, 2005, entitled “SYSTEM, APPARATUS AND METHOD FOR ADDRESS FORWARDING FOR A COMPUTER NETWORK,” by Yao, et al.

### FIELD OF THE INVENTION

The present application is related to computer networks. More specifically, the present application is related to a system and method for address forwarding in a computer network.

### BACKGROUND OF THE INVENTION TECHNOLOGY

Current Storage Area Networks (SANs) are designed to carry block storage traffic over predominantly Fibre Channel standard medium and protocols. There exist several proposals for moving block storage traffic over SANs built on other networking technology such as Gigabit Ethernet, ATM/SONET, InfiniBand or other networking medium and protocols. Currently, to bridge or interconnect storage data traffic from SANs built on one medium/protocol type to another SAN built on an incompatible medium/protocol type requires a special device that performs the protocol/medium translations. These bridges or translation devices make the necessary translations between these two protocols/mediums in order to serve the clients (host computers/servers and storage target devices).

It is difficult to build heterogeneous SANs that are scalable using these bridges/translation devices because the bridges/translation devices usually become the bottleneck as the number of clients and the number of storage devices increase. In addition, a mixed protocol environment requires the installation of complex software on these bridges/translation devices. The complexity of this software increases with the number of protocols involved. Accordingly, the performance of these bridges/translation devices will be negatively impacted. Furthermore, the routing process requires a table lookup for every data frame that passes through every port. Table lookup is required even for internal port to port delivery. In addition, the routing information may be buried deep inside the data portion of each frame. If so, the routing software must check inside the data and accordingly diminish performance.

### SUMMARY OF THE INVENTION

The present disclosure describes system, apparatus and method for address lookups and switching for Fibre Channel to Fibre Channel devices. The present disclosure also describes a system, method and apparatus for address translation between Fibre Channel and iSCSI or InfiniBand devices. In addition, the present disclosure describes a system, apparatus and method for address translation for Fibre Channel to IP or ATM encapsulation to enable any of the mixed protocol communications using the storage network switch system.

The system, apparatus and method of the present disclosure takes advantage of the system architecture to achieve internal routing with minimal table lookups. Furthermore, the present disclosure provides efficient address translation between Fibre Channel and IP frames to support communications between Fibre Channel and iSCSI devices, and Fibre Channel over IP communication. In one exemplary embodiment of the present invention, the addressing scheme includes the systematic assignment of device addresses with fields that closely correlate to the internal port addresses. This scheme allows for fast routing and minimizes the occurrence of table lookups.

In one exemplary embodiment of the present invention, the addressing scheme includes assigning an internal port address to uniquely identify a port associated with a routing processor of a network device associated with, and having a location within, a system, by allocating a location section of the internal port address corresponding to the location of the network device; allocating a routing processor section of the internal port address corresponding to a routing processor associated with the routing processor; and allocating a port section of the internal port address corresponding to the port. In another exemplary embodiment of the present invention, the addressing scheme involves mapping an internal port address comprising a location section, a routing processor section and a port section to a network protocol address, by mapping the location section to a first selected section of the network protocol address; mapping the processor section to a second selected section of the network protocol address; and mapping the port section to a third selected section of the network protocol address.

Other and further objects, features and advantages will be apparent from the following description of exemplary embodiments of the invention, given for the purpose of disclosure and taken in conjunction with the accompanying drawings.

### BRIEF DESCRIPTION OF THE DRAWINGS

A more complete understanding of the present disclosure and advantages thereof may be acquired by referring to the following description taken in conjunction with the accompanying drawings, wherein:

FIG. 1 is a schematic representation of a computer network switch system;

FIG. 2 is a schematic representation of a line card;

FIGS. 3 and 4 are schematic representations of port address content;

FIG. 5 is a diagram of Fibre Channel address mapping;

FIGS. 6a and 6b show the organization of port address assignments;

FIG. 7 is a schematic diagram of a line card and iSCSI device connections;

FIGS. 8 shows the organization of port address assignments;

FIG. 9 shows a routing table map;

FIG. 10 is a schematic block diagram of a computer network;

FIGS. 11 and 12 are routing tables;

FIG. 13 shows a lookup table;

FIG. 14 shows a computer network; and

FIGS. 15 and 16 are flow charts of routing processes, according to exemplary embodiments of the present invention;

FIG. 17 shows a routing table; and

FIG. 18 shows a routing table map.

While the present invention is susceptible to various modifications and alternative forms, specific exemplary embodiments thereof have been shown by way of example in the drawings and are herein described in detail. It should be understood, however, that the description herein of specific exemplary embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF THE PREFERRED EMBODIMENTS

The present disclosure relates to a system, apparatus and method for allowing communications between network devices that utilize different protocols. Disclosed herein are addresses and commands between various protocols that may be used by network devices. Accordingly, a computer network switch system may support several types of communication modes including a Fibre Channel switch mode for Fibre Channel to Fibre Channel communication, a Fibre Channel to iSCSI mode for Fibre Channel to iSCSI communication transferred over the Ethernet via TCP/IP, and a Fibre Channel encapsulation mode for Fibre Channel communication encapsulated over IP protocol for transmission over Ethernet.

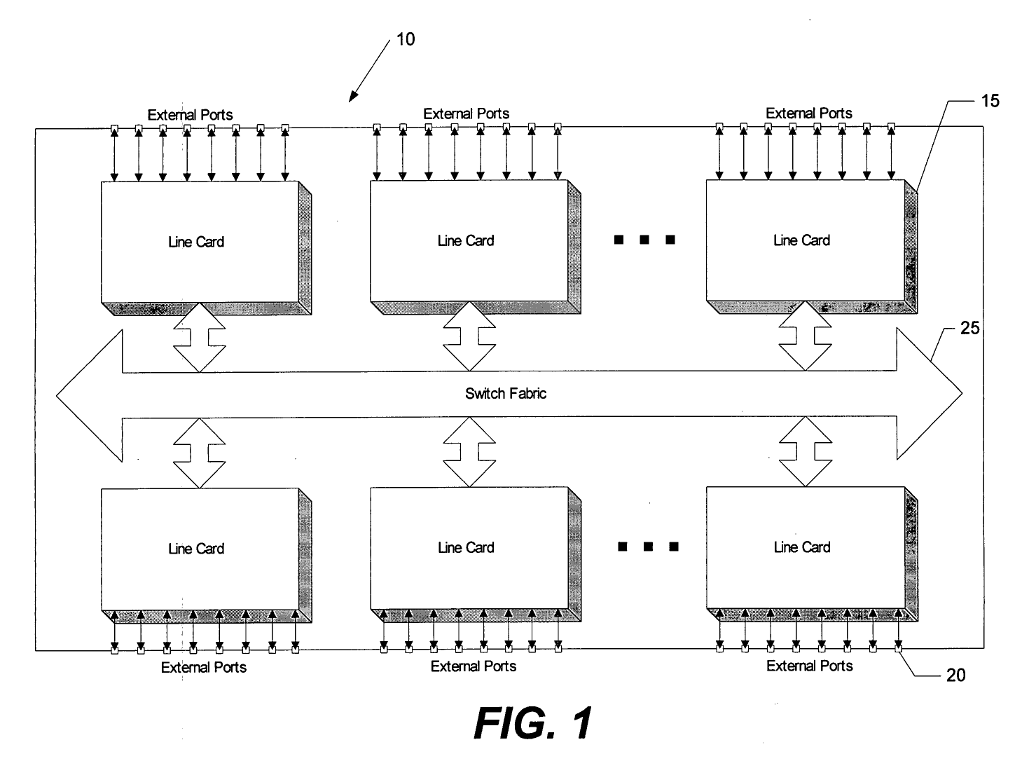

Ideally, storage network switch systems will have ports that support different protocols and network media so that different types of hosts and storage devices may be attached directly to the switch system and start communicating with each other without any translation overhead. For example, the storage network switch system as shown in FIG. 1 supports mixed protocol line card ports. In order to communicate between any two ports, the source and destination ports must be identifiable in both the source and destination protocol. For example: to send a message or frame from a Fibre Channel port to a Gigabit Ethernet port, the destination port needs to appear as a Fibre Channel port to the source port; and the source port needs to appear as a Gigabit Ethernet port to the destination port. According to the Fibre Channel standards, each Fibre Channel port has a unique address ID within a storage area network. The ID is 24-bits wide and is partitioned into three fields: 8-bits of domain ID, 8-bits of area ID, and 8-bits of port ID. The Fibre Channel address ID's are assigned by the switch devices within the boundaries of a switched network. Correspondingly, each Gigabit Ethernet port has a globally unique 32-bit IP address.

As discussed above, the presently disclosed storage network switch system supports at least three types of communications modes: Fibre Channel Switch Mode (Fibre Channel to Fibre Channel), Fibre Channel to iSCSI Mode (Fibre Channel to iSCSI over TCP/IP over Ethernet), and Fibre Channel over IP Encapsulation Mode (Fibre Channel to Fibre Channel encapsulated over IP over Ethernet). For communications between Fibre Channel devices, there is no need to do any address or command translations, it just follows the Fibre Channel protocols from the source to the destination. For communications between, for example, Fibre Channel and iSCSI devices, both the addresses and the commands need to go through translations so that the device on either end of the switch thinks it is talking to another device of the same kind. For Fibre Channel over IP type of communications, the original Fibre Channel frames have to be encapsulated inside an IP header with the appropriate translated source and destination IP addresses in order to tunnel the frames across an Ethernet LAN, and vice versa.

The address and command translation used for Fibre Channel and iSCSI devices also applies to communications between Fibre Channel and InfiniBand devices. The method described here for Fibre Channel encapsulated over IP also applies to the Fibre Channel encapsulated over ATM/SONET.

FIG. 1 shows a schematic diagram of a switch system, indicated generally by the numeral 10, for a computer network, such as a storage network for example. Switch system 10 includes one or more line cards 15. Each line card 15 has one or more external ports 20 that are suitable for providing a connection with a network device. For example, ports 20 are suitable for connecting to hosts, storage devices, and other switch or router devices. Typically, each line card 15 may have eight ports 20. In general, each port 20 communicates with other ports 20 and transfers data through a high-speed switch fabric interface 25.

Switch system 10 supports several types of ports 20. For example, switch system 10 supports Fibre Channel ports, Gigabit Ethernet ports, InfiniBand ports, and ATM ports. A host, storage device or other network device, may be connected to any type of port 20 as long as that device has a proper host adapter for making the appropriate physical connection and the device is able to understand the associated communication protocol. In order for network devices based on different protocol types to communicate with each other, the network must implement a systematic method to uniquely identify the port in any of the supported protocols and translate between the various supported protocols. Typically, a master port address translation table is used to cross reference a given port between various protocols. For example, for a network that supports Ethernet, Fibre Channel, InfiniBand and ATM, a master port address translation table may maintain the Ethernet IP address, Fibre Channel address ID, InfiniBand local and global IDs and the ATM port addresses for each port. However, the switch must search through the master port address translation table every time a packet or frame of data is transferred in order to determine the correct destination for the data. Accordingly, the table lookup operations can adversely affect the transmission performance of the switch.

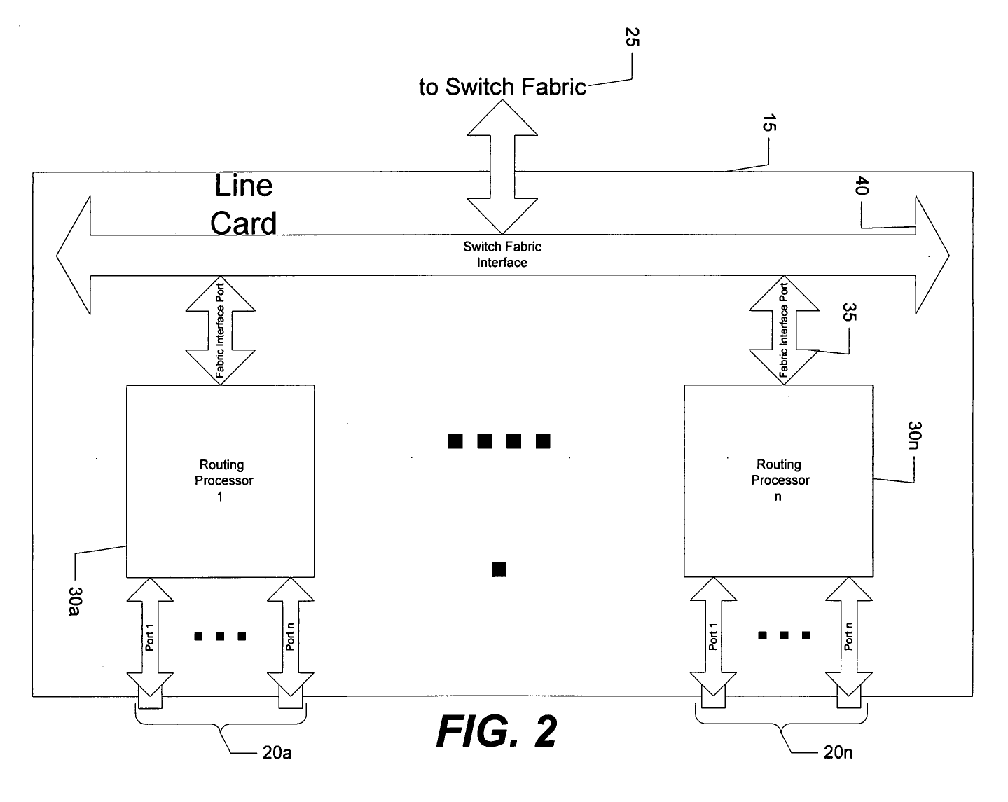

FIG. 2 shows a schematic representation of the architecture of a system line card 15. Each line card 15 has one or more routing processors 30. Each routing processor is associated with one or more ports 20 of line card 15. Routing processor 30 manages the data communications of its associated ports 20. Data is transferred between network devices via their respective ports 20. When a data packet is sent from a network device, it is first received by the port 20 associated with the transmitting device. The routing processor 30 associated with that port 20 reassembles the data into an external buffer and builds the necessary descriptor. The routing processor 30 then sends the packet to the switch fabric 25 via the switch fabric interface port 35 based on the results of the lookup operation.

The switch fabric 25 then sends data packets to the designated or receiving routing processor 30 via the switch fabric interface 40 and the fabric interface port 35 of the designated routing processor 30. The routing processor 30 reassembles the data into an external buffer and builds the necessary descriptor queue. The routing process 30 then sends the data to the designated port 20. When the data is received by the designated or receiving port, the data may be transmitted to the attached network device or devices that are intended to receive the data. Generally, the architecture of Fibre Channel line cards, Gigabit Ethernet line cards, InfiniBand line cards, and ATM line cards are similar.

Each Fibre Channel port in a Fabric 25 is given a unique port address by the Fabric 25. Typically, this Fibre Channel port address is 24 bits in length. This port address can be partitioned into three parts: a domain ID, an area ID and a port ID. For example, for a 24-bit address, the upper 8 bits are usually used as the domain ID, the middle 8 bits are used as the area ID, and the lower 8 bits are used for the port ID. Usually the Fabric switches implement a scheme to ensure that a unique port address is being assigned to all ports in the Fabric 25. For example, when Fibre Channel switches are connected together via their E_Ports, the switches negotiate among themselves to designate one of the switches as a principle switch. Generally, this negotiation is accomplished by comparing their world-wide names and/or switch priority. The principle switch is then responsible for assigning a domain ID to each switch within the principle switch's “autonomous region.” Each switch then assigns an area ID to each loop port within its own domain. Next, each switch groups the remaining ports and assigns an area ID to each group of ports. Each port in an area is then assigned, usually sequentially, a unique port ID.

An aspect of the present invention relates to an internal port addressing scheme to locate external ports on the computer network. The presently disclosed addressing scheme is used to generate internal port address IDs. As discussed above, in order to uniquely identify a port in the network, the shelf and the slot where the line card is located must first be known. Furthermore, for the card, one must know the fabric interface port ID or the routing processor ID. Finally, the port number from the routing processor must be known. Accordingly, the internal port address ID must contain the shelf and slot ID, a routing processor ID, and a port ID specifically corresponding to the external port. The shelf and slot ID may be read from the geographical locator indicators of the slot. The routing processor ID may be implied from the PCI slot ID on the line card processor PCI bus.

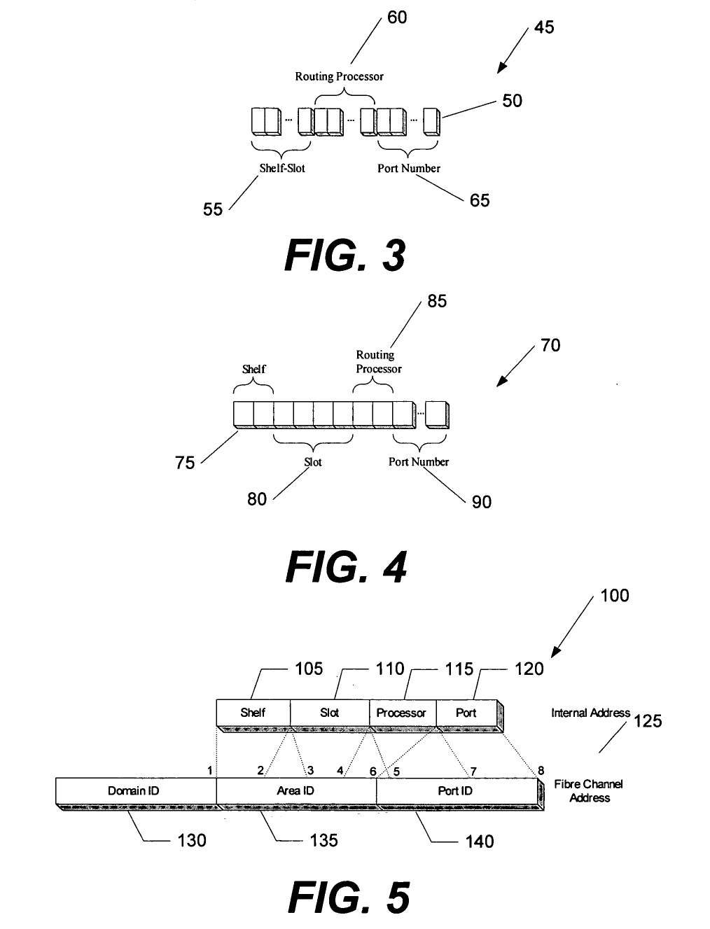

FIG. 3 shows an internal port address ID, shown generally at 45, wherein each block 50 represents one bit. The first component 55 of the internal port address ID 45 corresponds to the shelf-slot ID, the second component 60 corresponds to the routing processor ID, and the third component 65 corresponds to the port number ID. The number of bits required for the internal port address ID will depend on the size of the shelf-slot ID 55, the routing processor ID 60, and the port ID 65. The number of bits required to represent those IDs depend, in turn, on the number of shelves, slots, routing processors, and ports per processor for a given network. For example, FIG. 4 shows an internal port address ID 70 for a system with four shelves, wherein each shelf contains up to sixteen line cards, each line card contains four routing processors, and each routing processor has two external ports. The upper two bits 75 of the internal port address ID identify the shelf number. The following four bits 80 correspond to the slot ID within the shelf. The next two bits 85 identify the routing processor ID within the card. The remaining field 90 is used to specify the specific port on the routing processor. Note that this internal port addressing scheme is suitable for locating line card ports for all types of line cards in the system or network. Depending on the parameters underlying the internal port address ID, namely, the number of shelves in a system, the number of slots in a shelf, the number of routing processors in a line card, and the number of ports for each routing processor, the number of bits used to identify these parameters may be different from the example shown in FIG. 4.

One of the primary functions of a Fibre Channel line card is the Fibre Channel Switch Service. In addition to providing Simple Name Server service, routing and zoning, the Fibre Channel Switch Service also provides Fibre Channel address ID assignment to all Fibre Channel devices directly attached to the switch The Fibre Channel address ID assignment algorithm may also incorporate the internal port addressing scheme described above to enable a straightforward self-routing mechanism.

As shown in FIG. 5, the internal address 100 containing shelf, slot, processor, and port bits, 105, 110, 115 and 120, respectively, may be mapped onto the Fibre Channel address ID bit space 125 for the Fibre Channel address assignment. As discussed above, the Fibre Channel address ID 125 contains a Domain ID 130, an Area ID 135, and a Port ID 140. Accordingly, the shelf bits 105, slot bits 110, processor bits 115 and port bits 120 may be mapped to these three ID sections of the Fibre Channel address ID 125. For example, as shown in FIG. 5, the shelf bits 105 may be mapped into a range from point 1, the beginning of Area ID 135, to point 2 or 3, followed by mapping slot bits 110 to points 4 to 5, followed by the processor bits 115 to points 6 or 7, and finally port bits 120 which may extend to the end of the available address bits. This method of mapping the port internal address to the Fibre Channel address can provide unique addresses for a large number of ports. For instance, this method can support up to 2¹⁶ or 65,536 total ports in one system.

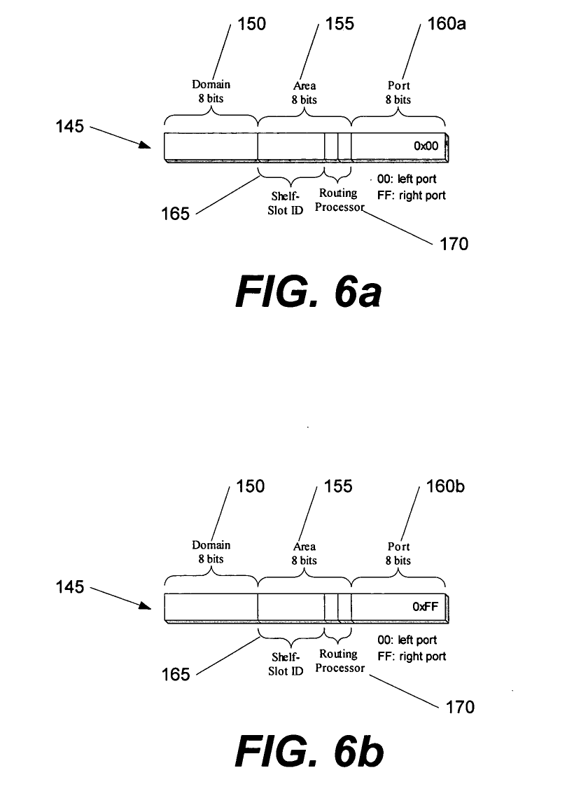

FIGS. 6a and 6b show an example of address mapping for a system with up to 512 ports, consisting of four shelves, sixteen slots per shelf, four routing processors per line card, and two ports per processor. In order to support this 512-port system, the address assignment scheme uses both the Area ID 155 and Port ID 160 in accordance with the Fibre Channel Switch Fabric-2 standard as shown in FIGS. 6a and 6b. For a 2-port per routing processor system, the left port will have an address ID assignment with a zero (0×00) port ID field 160a as shown in FIG. 6a. The other port, designated the right port, will have an address assignment of 0×FF port ID field 160b as shown in FIG. 6b.

The above address assignment scheme simplifies intra-switch routing. As discussed above, the 8-bit Area_ID 155 determines or identifies the fabric interface port 35 within the system. A fabric interface port 35 identifies the specific routing processor 30 for which a particular data frame is destined. In the example configuration shown in FIGS. 6a and 6b, the upper 6 bits of the Area_ID 155 is also the Shelf-Slot ID 165 of the line card 15. The Shelf-Slot ID 165 shown in FIGS. 6a and 6b provides addresses for a possible maximum of 2⁶ or 64 lots, which is sufficient to support a system with up to 64 line cards 15. As noted above, the size of Shelf-Slot ID bit field 165 may be increased to accommodate larger switch configurations. As discussed above, the example configuration corresponding to FIGS. 6a and 6b contains four routing processors 30 per line card 15. The lower 2 bits 170 of the Area_ID address 155 correspond to the particular routing processor. For configurations that support a larger Shelf-Slot ID 165, the additional bits required to fully specify the Fabric Interface Port ID can be allocated from the port ID field 160 of the FC address ID 145. Furthermore, the port number assignment may utilize the remaining space of the Fibre Channel port ID field 160. The self-routing property of the presently disclosed address assignment scheme allows routing to any port within the system without requiring any table lookup.

As discussed above, the iSCSI standard allows SCSI volume/block oriented devices to be attached directly to IP networks such as the Internet and Ethernet networks. The iSCSI standard maps the SCSI command sets to TCP and thereby allows for transmission over the network. There are several types of SCSI standards. For example, SCSI-3, also called Ultra Wide SCSI, uses a 16-bit bus and supports data rates of 40 MBps. Accordingly, with the iSCSI standard, the SCSI-3 command sets may be mapped to TCP for transmission across an Ethernet network. In order to communicate on an IP network, iSCSI devices must have unique valid IP addresses. IP address are assigned to iSCSI devices and entered into the system during the initial system configuration. For locally attached iSCSI devices, an administrator may manually assign IP addresses to the devices, or the IP addresses may be assigned automatically from a pool of pre-allocated IP addresses. Note that the presently disclosed addressing scheme may handle IPv.6 and other versions of IP because the addressing scheme does not limit address lengths.

An address resolution protocol (ARP) is performed to map an IP address to a physical address. ARP is a TCP/IP protocol used to convert an IP address into a physical address or a DLC address, such as an Ethernet address. Generally, ARP provides a mechanism so that a host can learn a receiver's physical address, such as a MAC address, when knowing only the IP address of the receiver. The host sends an ARP Request packet containing the IP address onto the TCP/IP network. The receiving host recognizes its own IP address and sends an ARP Response that contains its hardware address in response to the ARP Request. ARP Responses allow the system switch software to create routing tables for mapping IP addresses to physical addresses for all directly attached iSCSI devices.

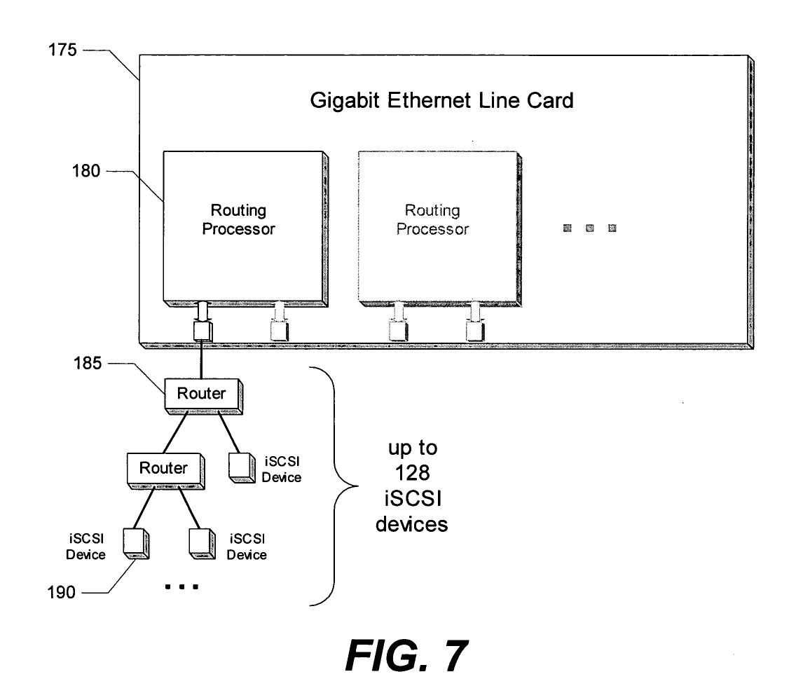

To enable communication between Fibre Channel and iSCSI devices, the iSCSI devices must appear as Fibre Channel devices to the Fibre Channel devices. Accordingly, iSCSI devices must be addressed using Fibre Channel addresses from the Fibre Channel side of the communication. Similarly, Fibre Channel devices must appear as IP protocol devices from the Gigabit Ethernet side of the communication. In order to present iSCSI devices as Fibre Channel devices, ‘pseudo’ Fibre Channel addresses are assigned to the iSCSI devices in addition to their own IP addresses. FIG. 7 shows a Gigabit Ethernet line card 175 containing one or more routing processors 180. As discussed above, each routing processor 180 provides a connection to a router 185 via its port. Each router 185 may provide a connection to another router 185 or other network devices such as an iSCSI device 190.

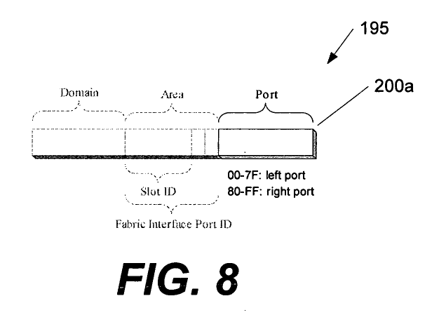

FIG. 8 shows the implementation of pseudo Fibre Channel address to an internal port address 195 for a two port routing processor 180. The pseudo Fibre Channel address may be assigned on the Gigabit Ethernet line card 180 by utilizing the Port_ID field 200 of the internal port address 195. Accordingly, the assignment of the pseudo Fibre Channel address does not interfere with the arbitrated loop addresses. For example, a general addressing scheme, hex 00-7F in the Port_ID field 200a can be assigned to devices connected to the left port as shown in FIG. 8. Similarly, hex 80-FF in the Port_ID field 200b can be assigned to devices connected to the right port as shown in FIG. 8. The Domain_ID and the Area_ID fields are assigned in the same manner as true Fibre Channel devices. In general, with this addressing scheme, any one Gigabit Ethernet port may support up to 128 iSCSI devices.

As discussed above, a pseudo IP address must be assigned to each Fibre Channel device in order for an iSCSI device to initiate communication to or respond to requests from a Fibre Channel device. These pseudo IP addresses may be assigned to the Fibre Channel devices in the same manner that IP addresses are assigned to iSCSI devices. For example, the pseudo IP addresses for the Fibre Channel devices may be manually assigned during the configuration process. Alternatively, the pseudo IP addresses may be assigned pursuant to an algorithm by network software.

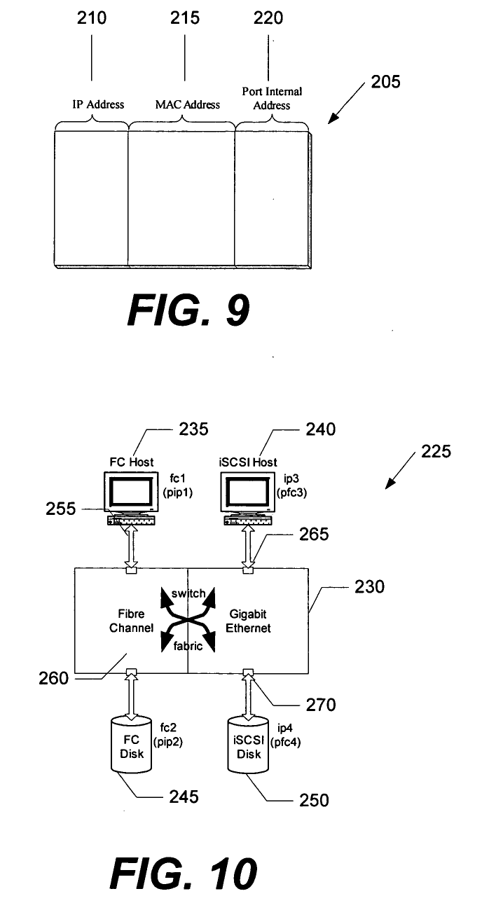

In order to route packets using the presently disclosed assignment scheme. A routing table must be used to map between the IP addresses and the Fibre Channel addresses of the attached devices bridged by the switch system. FIG. 9 shows an embodiment of a routing table 205 suitable for mapping between IP addresses and Fibre Channel addresses. Routing table 205 contains columns for the IP address, MAC address and Port Internal Address, 210, 215 and 220 respectively, for each network device. Fibre Channel addresses may be obtained from Fabric login information and name server lookups. IP addresses must generally be either manually entered or drawn from a pool of pre-allocated addresses. The IP address column 210 preferably contains the entire IP address, rather than just the Host_ID segment, to allow for different subnet ID's for each of the IP devices. The system also maintains a data field in the routing software module to enable Fibre Channel routing in the different protocol domains. This data variable corresponds to the global Fibre Channel domain ID of the system.

The Fibre Channel domain ID uniquely identifies a Fibre Channel switch in the routing of data packets. This ID is obtained through negotiation with all other connected switches during the Fabric building process. Each fabric switch assigns the addresses of all non-switch end devices that are connected to that switch. Accordingly, each Fabric switch uses the Fibre Channel domain ID as a root or domain ID field for all of the addresses that it assigns. When the domain ID field for a packet's destination address matches a switch's domain ID, then the packet is to be routed to a port for that switch. The Fabric switch performs this routing based on the internal port address and its own address assignment scheme. If the IDs do not match, the packet must go to an intermediate switch. The first switch looks up a routing table to find a port that connects to this intermediate switch. This intermediate switch will, in turn, make further routing decisions.

FIG. 10 shows a computer network, indicated generally at 225, with a Fibre Channel/Gigabit Ethernet switch fabric 230. Both Fibre Channel and iSCSI devices are locally attached to the switch fabric 230. The Fibre Channel devices include Fibre Channel host 235 and Fibre Channel device 245. Fibre Channel device 245 may be any device utilizing the Fibre Channel protocol, such as a storage device. The iSCSI devices include iSCSI host 240 and iSCSI device 250. iSCSI device 250 may be any device that utilizes the iSCSI standard, such as a storage device. Ports 255 and 260 are Fibre Channel ports. Ports 265 and 270 are iSCSI ports. Accordingly, there are four possible communications paths for computer network 225: from Fibre Channel to Fibre Channel, from Fibre Channel to iSCSI, from iSCSI to iSCSI, and from iSCSI to Fibre Channel.

As discussed above, each Fibre Channel device will have a Fibre Channel address and a pseudo IP address. For example, Fibre Channel host 235 may have a Fibre Channel address at “fc138 and a pseudo iSCSI address at “pip1.” Fibre Channel device 245 may have a Fibre Channel address at “fc2” and a pseudo iSCSI address at “pip2.” Similarly, each iSCSI device will have an IP address and a Fibre Channel address. For example, iSCSI host 240 may have an iSCSI address at “ip3” and a pseudo Fibre Channel address at “pfc3.” iSCSI device 250 may have an iSCSI address at “ip4” and a pseudo Fibre Channel address at “pfc4.”

The communication between Fibre Channel host 235 at address fc1 and Fibre Channel device 245 at address fc2 is an example of the first possible communication path, from Fibre Channel to Fibre Channel. Because fc2 is a Fibre Channel port, the Area_ID and the Port-ID portions of the Fibre Channel address are the same as the port internal address. According to an exemplary embodiment of the present invention, all Fibre Channel ports use their internal address as part of their Fibre Channel address. Accordingly, the system can easily route a frame from Fibre Channel host 235 to the destination port 260 using the internal port address of fc2. When the frame arrives at the destination port 260, the software responsible for routing or addressing frames recognizes that the frame is a Fibre Channel frame sent between two Fibre Channel frames. As a result, no address or command translation is required.

The transmission of a frame from Fibre Channel host 235 to iSCSI device 250 is an example of the second communications path, from Fibre Channel to iSCSI. To the Fibre Channel host 235, iSCSI device 250 appears to be a Fibre Channel device with a legitimate Fibre Channel address of pfc4, the pseudo Fibre Channel address of iSCSI device 250. Accordingly, Fibre Channel host 235 uses the “pfc4” address to communicate with iSCSI device 250. As discussed above, the frame is forwarded from Fibre Channel host 235 to the destination port 270 using the internal port address pfc4. Because port 270 is a Gigabit Ethernet port, the addressing software recognizes that the frame is being sent to an iSCSI device. The addressing software then uses translation table 205, shown in FIG. 9, to translate the pseudo Fibre Channel address into the real IP address. In this case, the addressing software consults the translation table 205 and determines that the pseudo Fibre Channel address pfc4 corresponds to the real IP address ip4. The addressing software also translates the Fibre Channel address fc1 of the initiator, Fibre Channel host 235, to its pseudo IP address pip1 using translation table 205. Next, the addressing software strips off the Fibre Channel header from the packet or frame and adds an IP protocol header. In addition, the addressing software performs a protocol translation from Fibre Channel to iSCSI for the data portion of the frame so that the entire data frame appears like a real iSCSI command. The addressing software then sends this modified frame to the port 270 on which the iSCSI device 250 is attached.

In the third case, iSCSI host 240 accesses an iSCSI target device 250. The destination IP address ip4 for target port 270 is used to determine the port's internal address from translation table 205. The addressing software uses the internal address to route the frame to the target port 270 and determines that the target port 270 is a Gigabit Ethernet port. Therefore, the addressing software does not need to translate the frame because both the initiator and target are iSCSI devices. Accordingly, the addressing software directly forwards the frame to the target port 270 using the original IP addresses and original iSCSI command without any translation.

In the fourth case, iSCSI host 240 at address ip3 communicates with Fibre Channel device 245 at address fc2. The initiator, iSCSI host 240, sends the frame to the target's pseudo IP address pip 2. The addressing software uses the target’s pseudo IP address as the lookup to the translation table 205 to find the port internal address for the target. Once the port internal address is determined, the addressing software forwards the frame to the target port 260 using the port internal address. Based on the port internal address, the addressing software determines that port 260 is a Fibre Channel port and makes the necessary translations between IP and Fibre Channel for both the source and the destination. The addressing software also translates the iSCSI commands to the corresponding Fibre Channel protocol command and then forwards the frame to the target Fibre Channel port 260. Although the examples discussed above in connection with FIG. 10 deal with directly attached devices on a single switch system, the present disclosure is also applicable to addressing between ports on multiple switch systems.

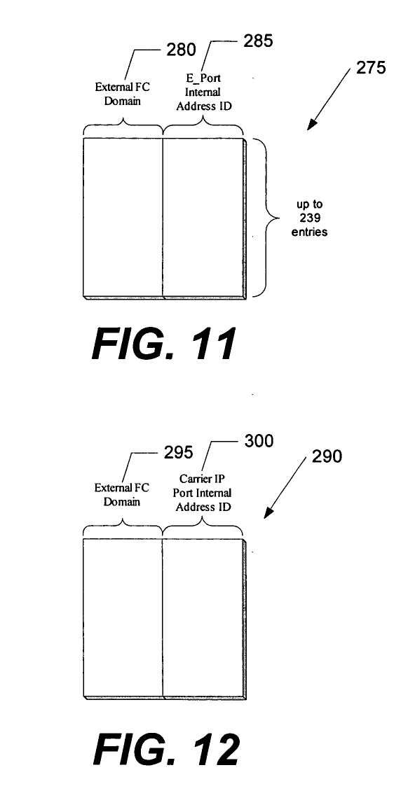

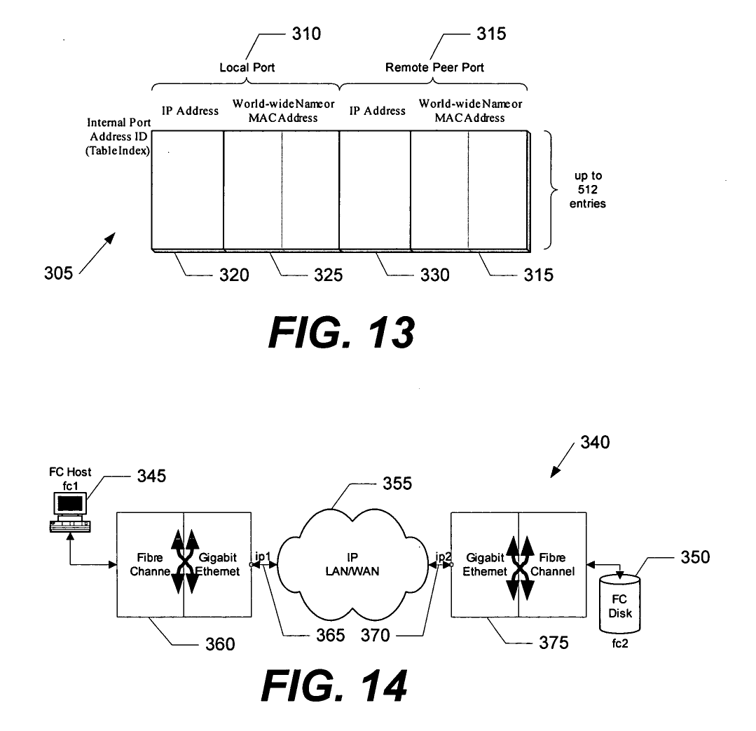

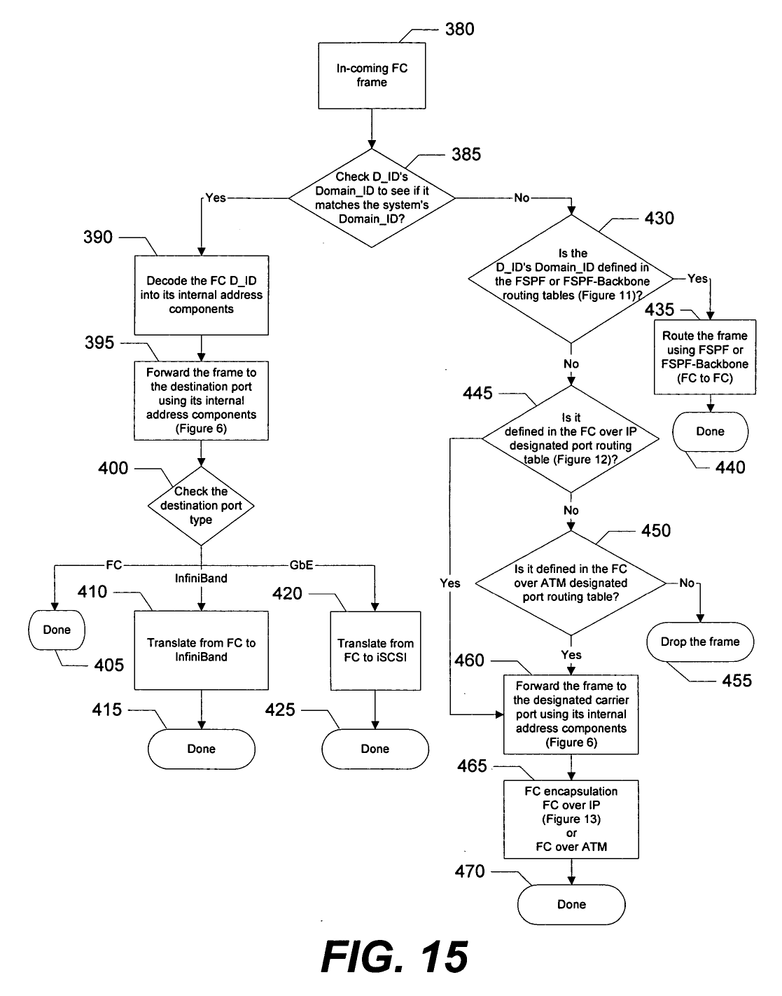

For a multiple switch system, each switch must properly and efficiently route frames that are intended for other switches. If an incoming Fibre Channel frame has a domain ID that does not match the Global Fibre Channel domain of the local switch, then this frame is intended for a destination device that is not directly attached to this switch. These frames must be routed using a routing table maintained by a Fabric Shortest Path First (FSPF) routing protocol. Generally, FSPF protocol utilizes routing tables as maps for routing traffic through the network in the most efficient manner by resolving the shortest paths for all the known domains within the switch's autonomous region. FIG. 11 shows a FSPF Fibre Channel domain routing table 275 that contains an external Fibre Channel domain column 280 and an E_Port Internal Address ID column 285. For each domain listed in the external Fibre Channel domain column 280, the E-Port Internal address ID column 285 contains an entry corresponding to the egress port for the shortest path to devices within that domain. Typically, the FSPF Fibre Channel domain routing table 275 may have as many entries as the total number of possible unique valid Fibre Channel domain IDs.

Transmitting or addressing Fibre Channel frames over IP protocol networks requires that the Fibre Channel frames be encapsulated. In general, encapsulation or tunneling is a technology that enables one network to send its data via another network's connections. Tunneling or encapsulation works by inserting a network protocol within frames or packets carried by the second network. Fibre Channel data may be transmitted across a TCP/IP network by embedding Fibre Channel network protocol within the TCP/IP packets carried by the TCP/IP network.

To support encapsulation of Fibre Channel over IP, certain external ports on selected Gigabit Ethernet line cards must be designated as the carrier IP ports. This designation is necessary because Gigabit Ethernet ports are general purpose ports and, in order for these ports to support encapsulation of Fibre Channel over IP, the system must recognize that these ports are being configured differently. A carrier IP port is a port on the Gigabit Ethernet line card that is designated or configured to transport the Fibre Channel over IP data traffic to another corresponding port on a corresponding switch. External ports may be manually designated as carrier IP ports as part of the system configuration management process. Conventional Fibre Channel standards do not implement carrier IP port functionality because Fibre Channel networks generally support multiple E_Ports to connect switches and because Gigabit Ethernet ports may serve as carrier IP ports. In Fibre Channel Networks, E_Ports are used to route Fibre Channel frames from one switch to another. The present disclosure achieves the same routing function using carrier IP ports through Ethernet networks, instead of Fibre Channel networks. Generally, the function of a carrier IP port for a Fibre Channel switch is analogous to an Ethernet port behind a B_Port.

In order to route Fibre channel traffic to carrier IP port, a separate routing table 290, shown in FIG. 12, is maintained using the FSPF Backbone Protocol. The FSPF protocol is then encapsulated over the IP frames. The format of carrier IP port routing table 290 is similar to that of the FSPF Fibre Channel domain routing table 275. IP routing table 290 contains an external Fibre Channel domain column 295 and an Carrier IP Port Internal Address ID column 285. For each domain listed in the external Fibre Channel domain column 295, the Carrier IP Port Internal Address ID column 285 contains an entry corresponding to the internal address for the carrier IP port for that domain. Typically, the carrier IP port routing table 290 may have as many entries as the total number of possible unique valid Fibre Channel domain IDs. Although the format of tables 275 and 290 are similar, the content of carrier IP port routing table 290 is interpreted differently than FSPF Fibre Channel domain routing table 275.

In addition, for the FCIP data frame to be transported over IP networks, another lookup table 305, shown in FIG. 13, linking the local and remote IP ports is required. Lookup table 305 contains two sections, 310 and 315, for the local port address and the corresponding remote peer port address, respectively. The local port section 310 contains two columns 320 and 325. The first column 320 contains the IP address of the local port, and the second column 325 contains the World-wide name or the MAC address of the local port. Lookup table 205 also contains an implied table index column associated with all of the other columns. The table 205 is constructed such that the internal port address ID or the pseudo Fibre Channel address ID can be used to index into the table 205 to find those IP addresses listed in the first column 320. The remote peer port section 315 also contains two columns 330 ad 335. The first column 330 contains the IP address of the remote peer port corresponding to the local port. The second column 335 contains the World-wide name or the MAC address of that remote peer port. Thus, each row of lookup table 305 contains the addresses of each local port and its corresponding remote peer port. Generally, the IP addresses in the lookup table 305 may be manually entered. The MAC addresses may be obtained for lookup table 305 through the ARP process. Typically, the lookup table 305 may have as many rows or entries as the total number of possible unique valid Fibre Channel domain IDs.

In order to route the FCIP (encapsulated Fibre Channel) data frame, the system looks up the Fibre Channel domain ID for the encapsulated Fibre Channel data frame's destination on lookup table 305 to determine corresponding IP carrier port address. Because the carrier port is on a Gigabit Ethernet line card 15, when a data frame is delivered to the carrier port, the software on that line card 15 must encapsulate the data frame with an IP header with source and destination IP addresses to allow the data frame to be transported over the IP network. The IP port addresses for the source and destination may be obtained from another address lookup table such as carrier IP port routing table 290, shown in FIG. 12. When the data frame is delivered over the IP network to the remote peer IP port, the FCIP software component of that Gigabit Ethernet line card 15 strips off the IP header and recovers the Fibre Channel address and completes the routing accordingly.

The present invention contemplates transmitting a Fibre Channel data frame from a Fibre Channel source to a Fibre channel destination via IP ports and IP networks. First, the source Fibre Channel port checks the destination domain ID against routing table 290, shown in FIG. 12, and determines the designated carrier IP port to which the packet must be sent in order to be routed to its destination. Upon receiving the data packet, the designated carrier IP port encapsulates the frame inside IP packets and checks against lookup table 305, shown in FIG. 13, for the destination IP address. Next, the carrier IP port forwards the now encapsulated data frame through the IP network to the destination carrier IP port. The destination carrier IP port then decapsulates the original Fibre Channel frame and routes the frame to the destination Fibre Channel port. Note that the presently disclosed system and method may also apply to transmitting Fibre Channel frames across other types of networks such as ATM protocol networks.

FIG. 14 shows an example of Fibre Channel over IP communication for a Fibre Channel/IP network, generally indicated at 340. Fibre Channel host 345 at address fc1 initiates a communication with Fibre Channel storage device 350 at address fc2. Because of the topology of network 340, this communication must be transmitted across an IP network 355. First, host 345 transmits a normal Fibre Channel protocol data frame with destination address identifier (D_ID) sets to address fc2. A D_ID is a value in the frame header of each frame that identifies the node port that is to receive the frame. The addresses fc1 and fc2 are located in different Fibre Channel domains, and therefore have different Domain_IDs. Because the Domain_IDs for fc1 and fc2 are different, the routing software checks the inter-switch routing table to determine where this frame should be sent. Using the Domain_ID of fc2 as the key, a table lookup of routing table 290, as shown in FIG. 12, returns an intermediate system internal port address ID. Given the intermediate address, the routing software delivers the frame to this internal port address by deciphering its internal address. The deciphering may be performed by software in accordance with FIGS. 3, 4, 5 and 6 and the related description. Because this port is a designated IP carrier port, this port will encapsulate the frame with an IP header when it receives the frame. Accordingly, a table lookup through table 305, shown in FIG. 13, must be performed to determine the source and destination IP addresses to be used in the IP header. For example, the IP addresses for source 354 and destination 350 may be ip1 and ip2, respectively. Once the Fibre Channel frame had been encapsulated inside the IP header, it is transported over the IP network 355 to the remote peer port ip2 370. When the ip2 line card receives the frame, it checks the protocol flag in the header and determines that this frame is a Fibre Channel over IP frame. Accordingly, the line card strips off the IP header and restores the original Fibre Channel data frame, and delivers the frame to the destination Fibre Channel port using the regular Fibre Channel routing method.

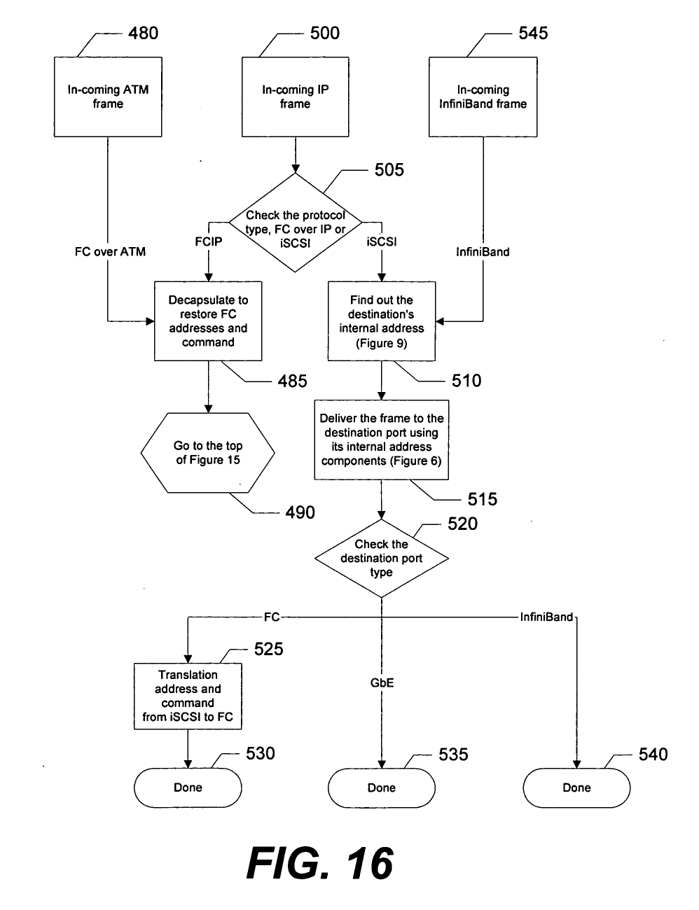

Generally, multiple tables may be required for different aspects of the routing process. The sequence of lookups to locate the correct route to the intended destination may vary according to the type of line card. FIG. 15 shows a flowchart depicting a routing process for a Fibre Channel line card. At step 380 an incoming Fibre Channel frame arrives at the Fibre Channel line card port. At step 385, the routing software compares the Domain_ID portion, e.g. the highest 8 bits, of the D_ID address to the Domain_ID of the system to determine whether the IDs match. If the Domain_ID of the incoming Fibre Channel frame matches the system's global Fibre Channel Domain_ID, then the routing software decodes the Fibre Channel D_ID into its internal address components, e.g. domain ID, shelf-slot ID, routing processor ID and port ID, as illustrated in FIGS. 3, 4, 5, and 6, at step 390. Next, at step 395, the routing software forwards the frame to the destination port using the internal address components.

At step 400, the routing software determines the protocol type of the destination port. For example, the protocol for the destination port may be Fibre Channel, InfiniBand, iSCSI, or other type of network protocol. If the destination port is a Fibre Channel port, then the frame may be directly forwarded to the Fibre Channel device at step 405. If the destination port is an InfiniBand port, then the address and commands must be translated from InfiniBand protocol to Fibre Channel protocol at step 410. The process of translating from InfiniBand protocol to Fibre Channel protocol may be performed in a manner similar to the Fibre Channel/iSCSI translation discussed above. A table similar to the table shown in FIG. 9 may be used to address the InfiniBand translation. The general algorithm discussed above may apply to all other devices that use similar addressing schemes to identify themselves. Once the translations have been performed, the frame may be forwarded to the InfiniBand device at step 415. If the destination port is a Gigabit Ethernet port, then the routing software must consult the IP address route lookup table 205 and make the necessary address and command translations from Fibre Channel to iSCSI at step 420. Once the translations have been performed, the frame may be forwarded to the IP device at step 425.

If the routing software determines that the Domain_ID of the incoming Fibre Channel frame does not match the system's global Fibre Channel Domain_ID at step 385, then the Fibre Channel address ID is not in the system's domain. The routing software must then determine at step 430 whether the Domain_ID of the D_ID is defined in the FSPF routing table or FSPF backbone routing table 275, as shown in FIG. 11. If the Domain_ID is defined in FSPF routing table 275, then a Fibre Channel routing port is available and its address may be obtained from table 275. Accordingly, the frame may be routed though this routing port as a Fibre Channel to Fibre Channel communication using FSPF or a Domain Manager Protocol (DMP) at step 435. DMP is an FC-SW-2 defined switch routing and control protocol that runs over a DMP-Backbone network. At step 440, the frame is delivered to the device.

If, at step 430, the routing software determines that a tables 275 or 290 do not contain the address for a Fibre Channel routing port, then the routing software may attempt to locate an IP carrier port. Accordingly, the routing software determines whether the Domain_ID of the D_ID is defined in the Fibre Channel over IP designated port routing table 290 at step 445. If the Domain_ID of the D_ID is not defined in the Fibre Channel over IP designated port routing table 290, then the routing software determines whether the Domain_ID of the D_ID is defined in the Fibre Channel over ATM designated port routing table 600 at step 450.

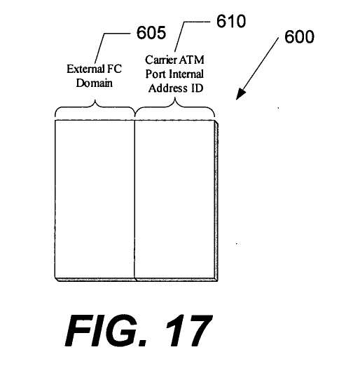

The Fibre Channel over ATM designated port routing table 600, shown in FIG. 17, contains an external Fibre Channel domain column 605 and a carrier ATM port internal address ID column 610. For each domain listed in the external Fibre Channel domain column 605, the carrier ATM port internal address ID column 610 contains an entry corresponding to the internal address for the designated carrier ATM port for that domain. Typically, the carrier ATM port routing table 6100 may have as many entries as the total number of possible unique valid Fibre Channel domain IDs. If the Domain_ID of the D_ID is not located in the Fibre Channel over ATM designated port routing table 600, then the frame is dropped at step 455. Note that due to the nature of the protocol and the supported devices, InfiniBand is treated like iSCSI in that the data frames are translated instead of encapsulated. Accordingly, for Fibre Channel devices to communicate with iSCSI or InfiniBand devices, the addresses and commands must be translated from Fibre Channel into iSCSI or InfiniBand. Preferably, the only incoming packets that are discarded are those packets for which a destination ID cannot be resolved from a search of all the available routing tables. The tables discussed above may be generated as part of the system configuration process. For example, the system administrator could populate these tables using a configuration software program. Alternatively, the values for these tables may be automatically generated.

If the Domain_ID of the D_ID is defined in either the Fibre Channel over IP designated port routing table 290 or the Fibre Channel over ATM designated port routing table, then the routing software forwards the frame to the designated carrier port using the internal address components, at step 460. At step 465, the routing software strips off the encapsulating protocol header, e.g. IP or ATM protocol header, to recover the Fibre Channel address. If the Fibre Channel frame has been encapsulated over IP, the routing software will lookup the IP addresses for the local and remote peer ports on table 305. At step 470, the frame is delivered to the target device.

FIG. 16 shows a flowchart depicting a routing process for a Gigabit Ethernet line card. As discussed above, the presently disclosed system and method for addressing may also be used for a variety of protocols, including Fibre Channel, IP, iSCSI and InfiniBand for example. As a result, the sequence of lookups to locate the correct route to the intended destination may vary according to the type of protocol and line card. For example, at step 480, the Gigabit Ethernet line card receives an incoming ATM frame. In this case, the ATM frame encapsulates a Fibre Channel frame. Accordingly, at step 485, the ATM frame is decapsulated to restore the Fibre Channel addresses and command, as discussed above. Because the Fibre Channel addresses have been recovered, the frame may be routed to a Fibre Channel line card. Accordingly, from step 490 of FIG. 16, the routing process may continue at step 380 of FIG. 15.

Alternatively, the Gigabit Ethernet card may receive an incoming IP frame at step 500. The incoming IP frame may represent different types of protocols. For example, the incoming IP frame may be a Fibre Channel over IP frame or an iSCSI frame. Therefore, the routing software determines the type of protocol at step 505. If the protocol type is Fibre Channel over IP, then the frame is decapsulated at step 485 to restore the addresses and command. The routing process may then proceed as shown in FIG. 15, starting at step 380.

If the routing software determines that the incoming IP frame is an iSCSI frame, then the internal address of the destination must be determined at step 510, using the table shown in FIG. 9. This determination may be based on the protocol information stored in the header of the data frame. Next, at step 515, the routing software delivers the frame to the destination port using the internal address components, as shown in FIG. 6. Because the network system incorporates several types of protocols, there will be different types of lines cards. Accordingly, the routing software must then determine the destination port type at step 520. For example, the destination port may be a Fibre Channel port, a Gigabit Ethernet port, or an InfiniBand port, among other types.

If the destination port is a Fibre Channel port, then the address and command must be translated from iSCSI to Fibre Channel at step 525. The frame may then be sent to the Fibre Channel destination port at step 530. If the destination port is a Gigabit Ethernet port, then no translation is necessary. Consequently, the frame may be directly sent to the Gigabit Ethernet destination port at step 535, respectively.

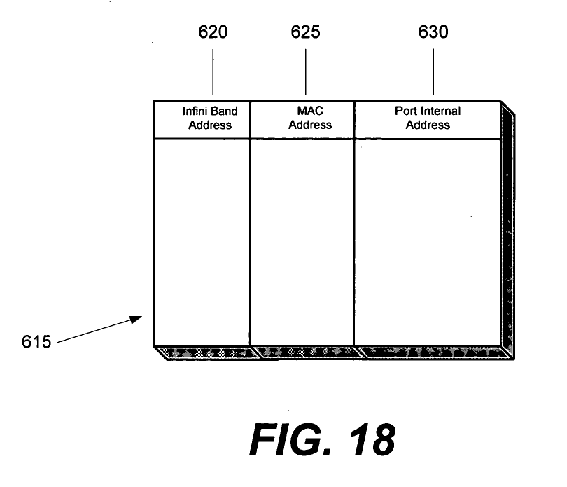

The Gigabit Ethernet line card may also receive an incoming InfiniBand frame at step 545. In this case, the routing software first determines the internal address of the destination port using routing table 615, shown in FIG. 18. Similar to the routing table 205, shown in FIG. 9, routing table 615 contains a column 620 for the InfiniBand address, and columns 625 and 630 for the corresponding MAC address and port internal address, respectively. Next, at step 515, the routing software delivers the frame to the destination port using the internal address components as shown in FIG. 6. The routing software then determines the protocol type of the destination port. If the destination port is a Fibre Channel port, then the address and commands must be translated from InfiniBand protocol to Fibre Channel protocol at step 525. The frame may then be delivered to the Fibre Channel device at step 530. If the destination port is an InfiniBand port, then the frame may be delivered without translation at step 540.

The invention, therefore, is well adapted to carry out the objects and attain the ends and advantages mentioned, as well as others inherent therein. While the invention has been depicted, described, and is defined by reference to exemplary embodiments of the invention, such references do not imply a limitation on the invention, and no such limitation is to be inferred. The invention is capable of considerable modification, alternation, and equivalents in form and function, as will occur to those ordinarily skilled in the pertinent arts and having the benefit of this disclosure. The depicted and described embodiments of the invention are exemplary only, and are not exhaustive of the scope of the invention. Consequently, the invention is intended to be limited only by the spirit and scope of the appended claims, giving full cognizance to equivalents in all respects.

1. A method of routing a data frame from a source device utilizing a first protocol over a network utilizing a second protocol to a target device port utilizing a third protocol and associated with an internal port address, comprising:
delivering the frame to the internal port address.

2. The method of claim 1, wherein the first protocol is a different protocol from the third protocol, further comprising:
translating the data frame from the first protocol to the third protocol.

3. The method of claim 1, wherein the first protocol is a different protocol from the second protocol, further comprising:
encapsulating the data frame over the second protocol;
transmitting the encapsulated data frame over the network; and
decapsulating the data frame.

4. The method of claim 3, wherein the first protocol is a different protocol from the third protocol, further comprising:
translating the data frame from the first protocol to the third protocol.
